(19) United States
(12) Patent Application Publication
(10) Pub. No.: US 2010/0175377 A1
(43) Pub. Date: Jul. 15, 2010

(54) COOLING AN ELECTRICALLY CONTROLLED TURBOCHARGER

(76) Inventors: Will Hippen, Santa Barbara, CA (US); Franz Laimboeck, Goleta, CA (US); Peter Hofbauer, Troy, MI (US); Tyler Garrard, Buellton, CA (US)

Correspondence Address: PAUL K. GODWIN;Paul K. Godwin, P.C., 7218 Pine Vista Dr., Brighton, MI, 48116, US

(21) Appl. No.: 12/417,568

(22) Filed: Apr. 2, 2009

Related U.S. Application Data
(63) Continuation-in-part of application No. 61/144,123, filed on Jan. 12, 2009.

(51) Int. Cl. F02D 23/00; F02G 3/00

(52) U.S. Cl. 60/602; 60/616

(57) ABSTRACT

An electrically controlled turbocharger has a motor mounted on a shaft in a motor housing between a turbine and compressor. Oil is sprayed onto the motor stator to cool the stator. Flingers on the shaft fling oil back onto the stator.

### NOTICE OF COPYRIGHTS AND TRADE DRESS

A portion of the disclosure of this patent document contains material that is subject to copyright protection. This patent document may show or describe matter that is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

Electrically controlled, engine exhaust gas turbochargers.

2. Description of the Related Art

Turbochargers use an engine's own exhaust gases to compress and, thus, increase the volume of air entering the engine to increase engine efficiency.

Engine exhaust gases from the exhaust manifold drive a turbine at high speed. Turbine rotation rotates a shaft, which is shared with a compressor. The compressor compresses outside air and delivers it to the engine's intake manifold. Compression causes more air and thus more oxygen to enter each combustion cylinder. Consequently, the engine operates more efficiently, at higher horsepower and torque and with lower cylinder displacement than conventionally aspirated engines. Thus, lighter engines using less fuel can provide equal performance than engines without a turbocharger provide.

Few diesel engines in new vehicles today operate without a turbocharger. Turbochargers also are becoming more common on gasoline engines. Other, non-vehicle engines also benefit from turbochargers.

At low engine revolutions, the exhaust flow may not drive the turbocharger sufficiently to obtain sufficient compressor rotation to force enough air from the compressor to the engine's intake manifold. Thus, when a driver accelerates quickly from idle or low engine revolutions to high engine revolution, a turbocharger lags until the volume of exhaust gases from the higher engine revolutions reaches the turbocharger. Accordingly, just when an engine is called upon to deliver more power, the lagging turbocharger supplies less then the desired airflow to the engine's combustion cylinders.

Because of these issues, some have proposed that turbochargers operate under electrical control from an electric motor within the turbocharger. See, for example, Kawamura, U.S. Pat. No. 4,769,993 (1988) and Halimi, U.S. Pat. No. 5,605,045 (1997). At idle when the driver wants to accelerate rapidly, a motor can accelerate the compressor quickly to supply sufficient air to the intake manifold and the combustion cylinders. After the engine reaches higher rpm and produces higher exhaust volume for adequate turbine rotation, the turbocharger does not rely on the motor. Then, the motor could function as an alternator and convert the turbocharger's rotary motion into electrical energy to supply at least part of the vehicle's electrical needs. For example, the alternator could charge batteries or supply other electrical needs of a hybrid vehicle.

Significant challenges still exist so that the motor continues to function in the harsh, high temperature, high speed environment of a turbocharger. The high gas temperatures on the turbine side of a turbocharger (≈1050° C. in gasoline engines; lower in diesel engines), adversely affects the entire structure. In addition, the compressor side of the turbocharger causes significant temperature increases because the increase in air pressure raises the air temperature, up to an increase of about 180° C. Moreover, resistance heating in the motor's stator adds to the turbocharger's heat load.

Turbocharger manufactures have built standard turbochargers with designs and materials to account for these high temperatures. Nevertheless, those structures and materials may not protect internal motors inside electrically controlled turbochargers adequately.

High temperatures affect the motor in several ways. Insulation on the electromagnets' coil wiring can melt. The melting exposes bare wiring and can short the coils. If the motor shorts, the electrically controlled turbocharger fails to function. Electric resistance of copper wire also increases linearly with increased temperature. This higher resistance at high temperatures decreases motor efficiency and causes the coils to generate more of their own heat. In fact, resistance heating of the coils can generate more heat to the motor than the heat the motor receives from the exhaust gases heating the turbine section and the air compression heating the compression section.

High-speed rotation also causes problems. Because the turbine and compressor are adjacent each other in standard turbochargers, the shaft connecting the turbine and compressor is relatively short. With longer shafts accommodating a motor, slight imperfections in the shaft become magnified at the high rotational speed at which current turbochargers operate and future ones will operate. Centrifugal force follows the following equation:

F=m·ω²r (1)

where m is the mass, ω is the rotational speed (in radians per unit time) and r is the radius. For a rotating shaft assembly rather than a rotating mass, the equation becomes more complex. Nevertheless, the equation still shows that as the shaft's radius increases, which increases the mass, the centrifugal force increases too. In addition, as the shaft length increase, the shaft becomes more flexible and its natural frequencies drop. Thus, resonance occurs at lower speeds.

Unless the shaft is perfectly round and uniform, resulting unbalances cause centrifugal force, which tends to vibrate the shaft. Any oil on the shaft—oil within the motor housing is discussed later in this application—also may lead to slight imbalances of the shaft. As the shaft passes through natural frequencies, unbalances can amplify resonances that can affect the turbocharger adversely.

### DESCRIPTION OF THE DRAWINGS

FIG. 1 is a block diagram of an electrically controlled turbocharger.

FIGS. 2 and 3 are external perspective views of the electrically controlled turbocharger.

FIG. 4 is a cut-away view of the electrically controlled turbocharger.

FIG. 5 is a cross-section view of the electrically controlled turbocharger, and FIG. 6 is an enlarged portion of part of FIG. 5.

FIG. 7 is a perspective view of the turbocharger shaft, motor rotor and the moving parts of the turbine and compressor.

FIG. 8 is a perspective, cutaway view of the turbocharger shaft, motor rotor and the moving parts of the turbine and compressor.

FIG. 9 is a sectional view of the turbocharger shaft, motor rotor and the moving parts of the turbine and compressor.

When detailed descriptions discuss a reference numeral in one or more drawing figures, the element being discussed is visible in that drawing. The element also may be visible in other figures. In addition, to avoid crowding of reference numerals, one drawing may not use a particular reference numeral where the same element is in another drawing with the reference numeral.

### DETAILED DESCRIPTION

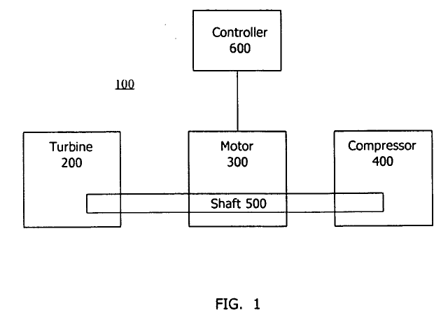

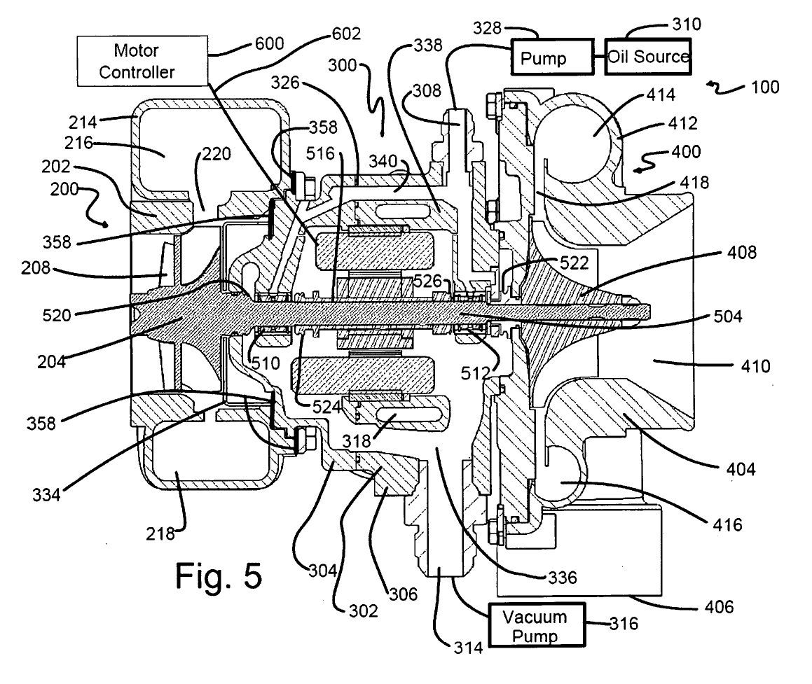

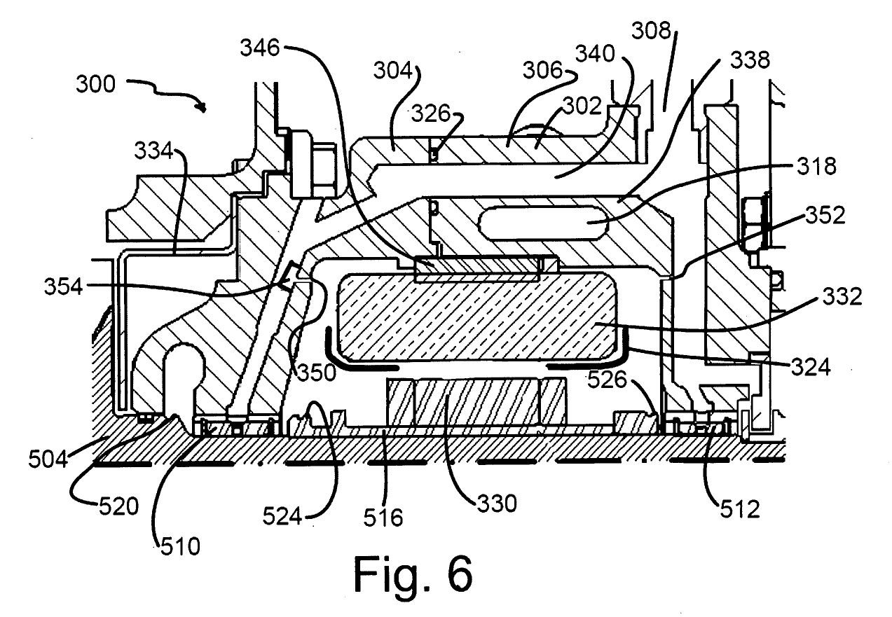

In the FIG. 1 block diagram, electrically controlled turbocharger 100 comprises a turbine 200, a compressor 400, a motor 300, a shaft assembly 500 and a controller 600. Motor 300 may be disposed between the turbine 200 and compressor 400, and shaft assembly 500 interconnects turbine 200, compressor 400 and motor 300. The turbine and compressor may be respectively secured to the motor to form a single unit. The turbine, compressor, motor and shaft assembly may have other relative physical arrangements. The controller 600 controls operation of the motor 300 through connection 602 (FIG. 5).

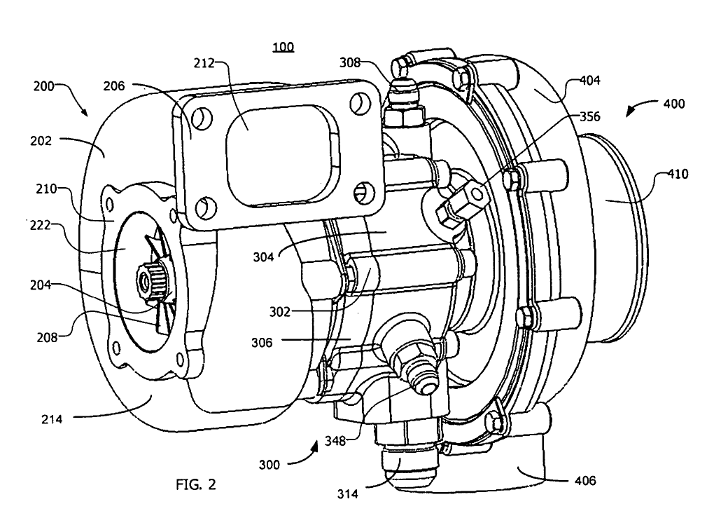

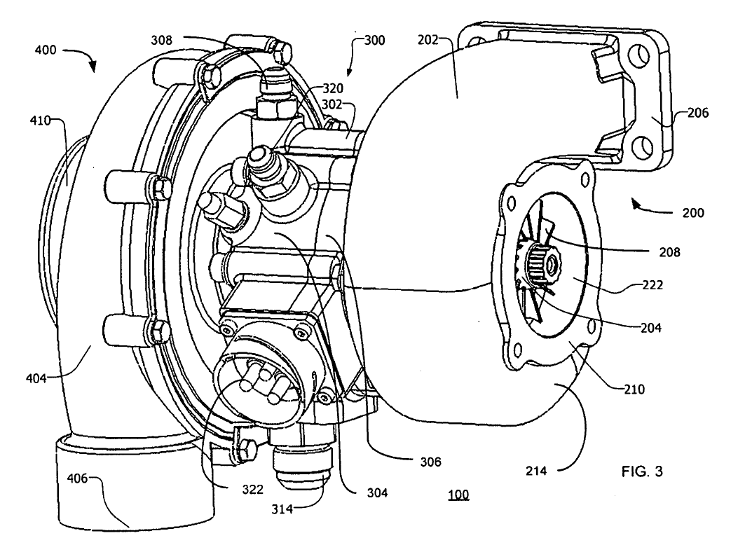

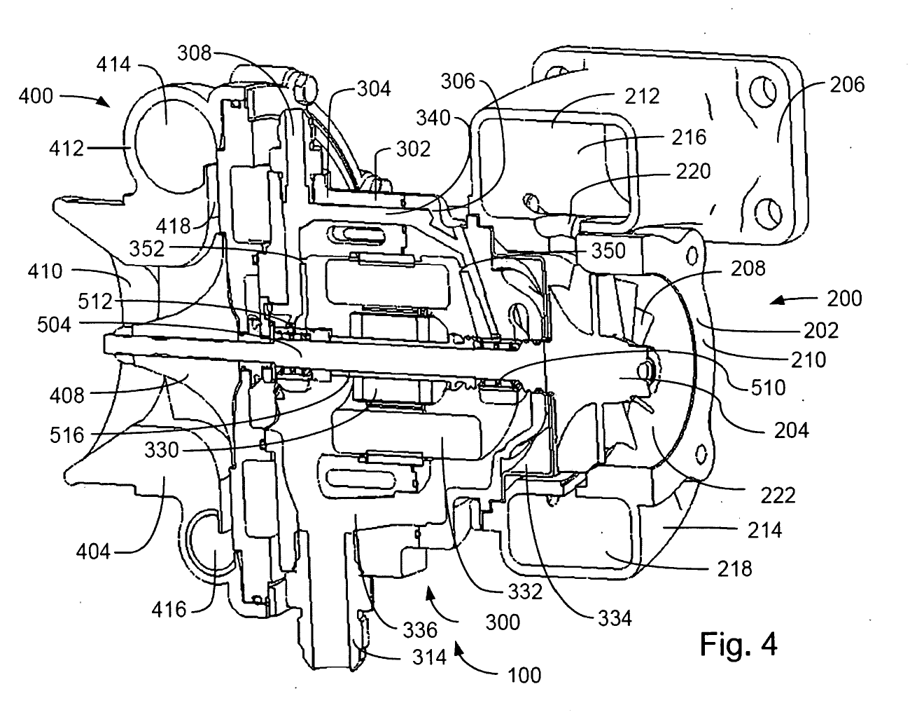

In the FIGS. 2 and 3 external perspective views of the electrically controlled turbocharger 100, housing 202 of turbine 200 includes inlet flange 206 at inlet 212. Exhaust gases from an engine (not shown) enter the inlet and flow through volute 214 (see also FIGS. 4 and 5). The volute may provide a spiral path for the incoming exhaust gases and, therefore, may have a decreasing dimension toward the center. Compare the dimensions at 216 and 218 (FIGS. 4 and 5). This decreasing dimension decreases the cross-sectional area of the volute as it spirals inward, which in normal operation causes increased velocity of the exhaust gases. Depending on the circumstances, it may be desirable for the volute to have some other shape.

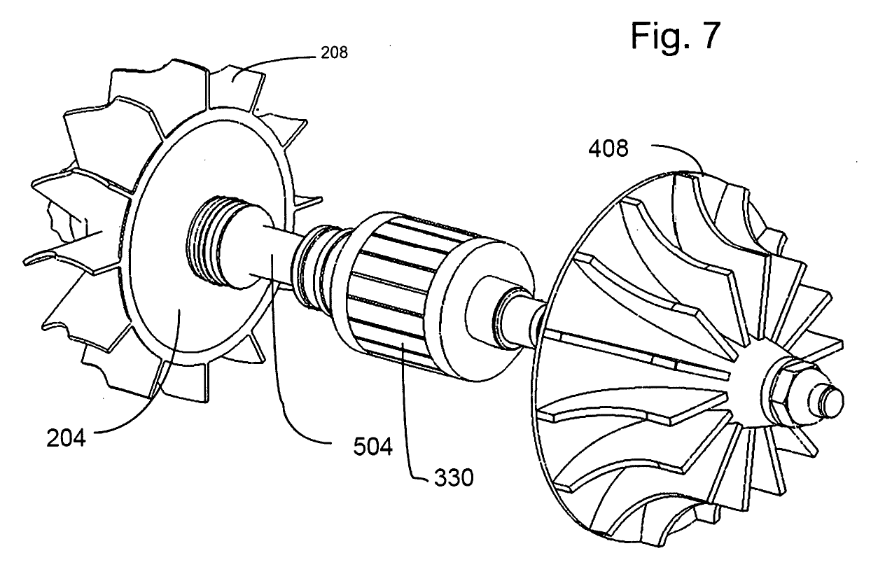

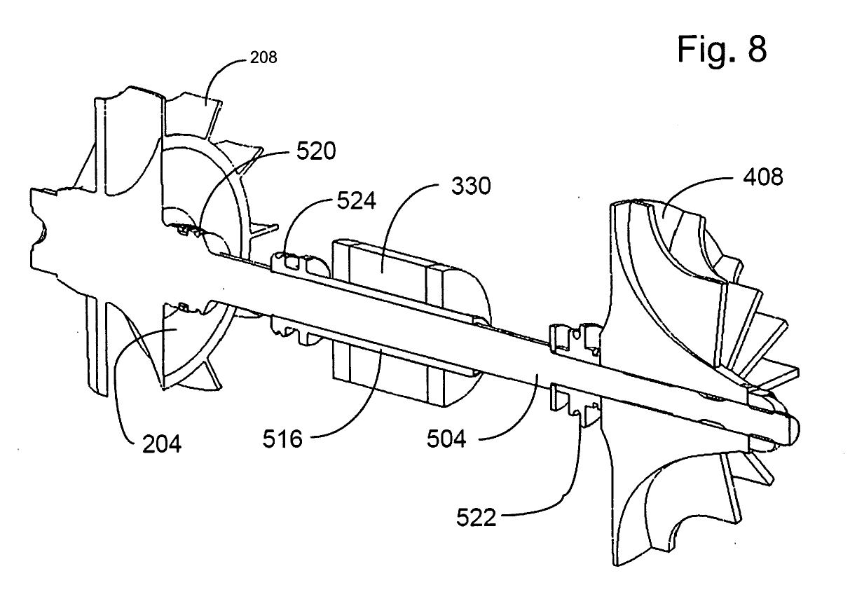

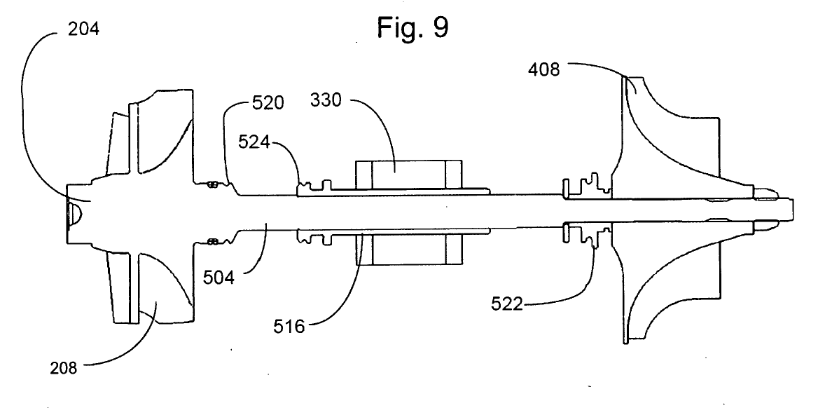

Volute 214 may have an inward-facing, tapered opening 220 (FIG. 4) communicating with the central portion 222 of turbine housing 202. Turbine wheel 204 has turbine blades 208 spaced around the turbine wheel. When exhaust gases pass though opening 220 from the volute, the gases push the turbine blades and cause the turbine wheel to rotate. See also FIGS. 7, 8 and 9 for other views of turbine wheel 204 and turbine blades 208 without the surrounding structure of the turbine housing 202.

Flange 206 may attach to a complimentary fitting on the engine exhaust manifold (not shown) so that exhaust gases enter inlet 212 and volute 214. After the exhaust gases rotate the turbine wheel, the spent gases may pass into an exhaust system, which may include the pollution reduction system, muffler and tailpipe. A portion of the exhaust gases may be directed to the intake manifold to recirculate exhaust gas back into the combustion process. Flange 210 may be provided to attach to the exhaust system.

Turbine housing 202 may be cast iron or another material with a high melting point that maintains its strength when subjected to high temperature exhaust gases, for example, up to ≈1050° C.

Turbine 200 may include a wastegate or other features that allow exhaust gases to bypass the turbine. When the turbine would be operating at above a designed output, too much heat and turbine speed can build up, and the compressor could provide too much compressed air to the engine combustion cylinders. The wastegate may solve this problem.

Compressor 400 includes a compressor housing 404 (FIGS. 2, 3 and 4). The compressor may discharge compressed air through an outlet 406 into the engine's intake manifold (not shown). The compressor may include a pressure relief valve (not shown). When the compressor would be operating at above a designed output, too much compressor speed can build up, and the compressor could provide too much compressed air to the engine combustion cylinders. The pressure relief valve may solve this problem.

The compressor 400 includes a compressor wheel 408 (FIGS. 4, 5, 7, 8 and 9). Outside air, e.g., from an air filter (not shown), is passed into the compressor through compressor inlet 410 (FIG. 4). Aperture 418 (FIGS. 4 and 5) communicates with the compressor inlet to direct air to diffuser 412, which may be a spiraling passage that tapers from a smaller internal size at 416 to a larger internal size at 414. The compressor wheel may draw air through inlet 410 and accelerate the air radially through aperture 418 to the diffuser 412. The diffuser increases the air pressure while decreasing its velocity.

Increased air pressure within compressor 400 may cause substantial heating of the air, which may cause compressor housing 404 and other parts within the compressor housing to become very hot. Some of this heat may be conducted to motor 300. An intercooler (not shown) may be provided between the compressor and the intake manifold, but the intercooler's primary function is to lower the air temperature and increase the air density. It normally does not decrease the transmission of heat from the compressor to the motor.

Motor 300 includes a housing 302 (FIGS. 2 through 5), which may be in two sections 304 and 306. The two sections may seal to each other but may be separable to provide internal access, for example for repairs and maintenance and to install the motor during assembly. One or more seals such as O-ring 326 (FIGS. 5 and 6) may seal the two housing sections.

Motor 300 may be an induction motor, a permanent magnet motor, a switched reluctance motor, or other types of motors or electric machine.

Motor 300 may include an oil inlet 308 for receiving oil and an oil drain 314 for passing oil out of the motor. See FIGS. 2 through 6. This oil may lubricate moving parts and cool parts of the motor. Source 310 of oil (shown schematically in FIG. 5) may be engine crankcase oil or a separate oil source. Some engines have engine-driven mechanical pumps that begin pumping oil into the engine when the engine begins operating. Those engines may rely on oil remaining on moving parts after engine shutdown for initial lubrication. Some parts of the turbocharger 100 may benefit from oil under pressure sooner. For example, adequate oil may be more critical for the turbocharger bearings than it is for cooling the turbocharger motor.

Crankcase oil's large volume provides a larger reservoir for dissipating heat from the turbocharger 100, as explained further in this application. The crankcase oil volume also could be increased, for example by one or more liters, to add to heat dissipating ability of the source of oil. An oil cooler also could be used. Conversely, using oil from a separate source prevents that oil from becoming contaminated by any conditions contaminating engine oil.

Whether the oil comes from the engine crankcase or from a separate source, a separate pump 328 (shown schematically in FIG. 5) may pump the oil for the stator and bearings. Such a pump could be electric or mechanical. An electric pump may initiate oil flow before the engine turns over, such as when the driver starts the car but before the engine's controller initiates ignition. This separate oil pump may be beneficial with engines that start and stop frequently such as those in hybrid vehicles. The separate oil pump may be thermostatically controlled and, therefore, may continue to run after engine shutdown until the temperatures in turbocharger 100 drop to acceptable levels.

Motor 300 may include an electrical connector 322 (FIG. 3) on motor housing 302, which provides electrical connections to the motor. Lead 602 from controller 600 (FIG. 5) may connect to the motor through electrical connector 322. The motor also may include coolant inlet 348 (FIG. 2) for receiving coolant and a coolant outlet 320 (FIG. 3) for returning coolant to a radiator or other source of cooling fluid. The cooling system may have a separate electrical or mechanical pump to direct coolant to the coolant inlet 348. That pump also may be under control of controller 600, which may receive data from a thermostat.

Motor housing 304 may be formed of cast iron or other appropriate material. The motor housing may include various internal supports. Cast iron can resist the substantial heat loads without weakening. Nevertheless, a ceramic or other insulator could replace or be used in addition to cast iron where forces on the parts of motor housing are not high. Ceramic may decrease heat flow from the turbine 200 to motor 300 and bearings 510 and 512 (described later and shown in FIG. 5).

When the engine operates at idle or low output and needs power for acceleration, low exhaust output may be insufficient to drive turbine 200 sufficiently to drive compressor 400 adequately. This lag may continue until the engine develops sufficient exhaust to drive the compressor at operating output. Controller 600 (FIG. 5) may receive data about engine conditions such as load, rpm, throttle position, fuel flow and other information and may control electrical power to motor 300. To overcome the lag, the controller may activate the motor to generate torque on shaft assembly 500, which causes the compressor to turn faster and to pressurize air up to the motor's full capacity even at lower engine speeds.

Shaft assembly 500 (FIGS. 2, 3, 6, 7, 8 and 9) includes a shaft 504, which connects to and extends from the turbine 200, through motor 300 and into compressor 400. Torque from exhaust gases acting on blades 208 of turbine wheel 204 causes the shaft to rotate. Rotation of the shaft may result in rotation of the compressor wheel 408.

Motor 300 has a rotor 330 (FIGS. 4 and 6 through 9) on shaft 504 that rotates with shaft rotation. Stator 332 (FIGS. 4 and 6) surrounds the rotor. The stator may have closely packed, insulated wires in coils (not shown) and a lamination stack 346. The material, gauge, winding, insulation and other features of the wire and the properties of the lamination stack may be chosen for their electrical, magnetic, environmental and other factors.

Motor 300 may be subjected to high temperatures from turbine 200 and compressor 400 and from resistance heating in stator 332. To cool the stator, oil may be jetted against the stator through oil jets 350 and 352. The jets are discussed below. The oil comes from oil source 310 (FIG. 5 in schematic), which may be the engine crankcase or a separate oil reservoir. The oil also may be from the same source that lubricates the turbocharger's bearings (described below). The oil flows along the stator 332 into sump 336 (FIGS. 4 and 5) where it collects and flows back to the crankcase or separate oil reservoir.

Radiant heat shield 334 (FIGS. 4 and 6) may be provided to reflect radiant heat from turbine 200 away from motor housing 302 and motor 300. One or more conductive heat shields 358 (shown schematically in FIG. 5) may be provided to resist heat transmission from compressor 400 or turbine 200 to the motor. The conductive heat shield may be ceramic or other appropriate material that resists heat transmission. Radiant heat shields may be metal or other material. Additional heat shields and insulation could be used elsewhere in turbocharger 100.

Turbocharger 100 can use different standard turbocharger turbine and compressor components, or the components may be specially constructed. In addition, turbine 200 and compressor 400 can use variable geometry. Dual sided compressor wheels could be used.

Two bearings 510 and 512 support shaft 504. See FIGS. 4 and 5. To accommodate motor 300 between turbine 200 and compressor 400, the shaft may be longer than standard turbocharger shafts, i.e., turbochargers without motors. This added shaft length may add to the length between bearings 510 and 512. This added length results in a weaker and more flexible shaft. As shaft 504 rotates at high speeds, it may pass through natural frequencies and cause resonance.

Therefore, the shaft assembly 500 may include a shaft stiffener 516, which may be a sleeve around or forming a part of shaft 504. See FIGS. 4, 5, 6, 8 and 9. The rotor may attach through an interference fit to the stiffener rather than directly in contact with shaft 504. The stiffener strengthens the shaft in a way that allows transient operation through, and continuous operation between resonant speeds.

Stiffener 516 may be made of an Inconel® alloy because Inconel also may act as a thermal barrier. Thus, stiffener 516 may reduce heat flow from the shaft 504 to the rotor 330. The shaft may be subjected to high heat loads from exhaust gases and hot, pressurized air in the compressor 400. The stiffener may be an assembly of a precision interference fit of two or more, highly controlled cylindrical parts to provide a mechanism of attachment between both the rotor and the stiffener, and the stiffener and the shaft. Splines or other serrated torque transmission mechanisms are alternatives, though they may be less desirable because of the difficulty in holding tolerances and increased local stress on the parts.

Shaft 504 may be stepped so that bearings 510 and 512 are of different sizes to accommodate differences in the shaft's outside diameter at the respective bearing. Each shaft bearing may include a journal bearing and a thrust bearing to permit rotation between parts while resisting axial loads. A single thrust bearing that resists axial loads in both axial directions may suffice. Thrust bearings rely upon a thin layer of pressurized oil or other liquid to support axial thrust. Likewise, a thin layer of oil in the journal bearings may separate the shaft 504 from the bearing structure and the motor housing 302. Rolling element bearings or a combination of rolling element and journal and thrust bearings also may be used.

Motor housing 302 may include interior structures that substantially encase stator 332 and rotor 330. Motor housing 302 may include one or more channel 340, which connect to the oil inlet 308. See FIGS. 4, 5 and 6.

Motor housing 302 may include one or more ducts 350 and 352, which jet oil from channel 340. See FIGS. 4 and 6. The ducts may act as nozzles to shoot oil against stator 332. The ducts may include separate nozzles or similar structures to dispense the oil. Likewise, the ducts may have shapes that cause the oil to exit the ducts in desired patterns such as fans, cones, straight streams, slow dribbles or other patterns or combinations of the patterns depending on the particular application. In addition, some ducts may spray in one pattern, and other ducts may spray in other patterns. Further, one or more ducts may have valves that cause the ducts to spray oil at predetermined intervals. The ducts may be sized to provide ample oil for cooling the stator without depriving bearings 510 and 512 of oil. In FIGS. 4 and 6, the ducts shoot oil from the sides of stator 332, but the ducts can be positioned elsewhere relative to the stator as long as an adequate supply of oil contacts the stator. For example, if one oil jet is used, it may be positioned to be sprayed at the top of the stator against the stator laminations so that the oil drains under gravity over the stator coils. Jets also could be positioned to spray oil in an axial or oblique direction. Additional ducts and/or openings may be provided throughout the motor housing and aimed so that oil reaches desired locations on the stator. Accordingly, oil from the engine crankcase or from another source of oil may be used to cool motor 300 and lubricate shaft bearings 510 and 512.

Stator 332 may be designed with exposed coils so that oil reaches the coils themselves. Oil is an electrical insulator so allowing oil to contact the coils will not cause shorts or allow electrical flow to adjacent coils or other structure in the motor. The stator may have one or more fins (not shown) to aid dispersing heat.

Because oil is used to cool stator 332, the oil supply for the bearings should be of sufficient capacity to compensate for oil used for cooling. A heat exchanger or other system for cooling the oil may be provided at appropriate locations in the oil system.

Ducts 350 and 352 may include respective valves to retard oil flow until the oil pressure reaches desired levels. See valve 354 shown schematically in FIG. 6. For example, the valves may open to spray oil onto the stator 332 only when bearings 510 and 512 have or are estimated to have sufficient oil. The valves can maintain a minimum oil pressure to the bearings without allowing oil pressure to drop because of oil flowing to the stator for cooling. Nevertheless, although a short delay pumping oil onto the stator for cooling may be acceptable to keep sufficient oil pressure for the bearings, the stator may begin heating quickly. Therefore, oil pressure to the bearings should reach operating pressure quickly so that oil can flow onto the stator quickly.

The oil flows around stator 332 and its coils and drips off into chamber or sump 336 (FIGS. 4 and 5). To keep oil off rotor 330, tray 324 (FIG. 6) may extend under part of the stator. The tray may extend about 180° around the stator. The tray may have one or more drains. When the oil reaches the edges of the tray, the oil drips into sump 336.

Oil in sump 336 may flow though an oil outlet 314 (FIGS. 2, 3, 4 and 5) from which the oil returns to the crankcase or other oil reservoir. The oil outlet may be sized and positioned appropriately to allow full drainage of oil at reasonable vehicle attitudes (slopes, tilt angles and angular and linear acceleration).

Vacuum pump 316 (FIG. 5) may apply vacuum to outlet 314 to draw oil through the outlet. Low pressure within motor housing 302 caused by the vacuum pump could pull exhaust gases from turbine 200 into the motor housing. Vent 356 (FIG. 2) may be included in the motor housing through which fresh ambient or crankcase air flows to prevent a vacuum from forming in the motor housing. Thus, the vent can prevent pulling exhaust gas into the motor housing 302. To prevent the vent from drawing water or other contaminates into motor 300, a filter, charcoal canister, one-way valve or other blockage device may be included.

Uncontaminated oil is a good electrical insulator, but oil can become contaminated with metal particles and water, both of which can be harmful to electrical devices. Therefore filtering out contaminates and separating out water from oil used in turbocharger 100 may be merited. Conventional engine oil filters and oil/water separators likely are adequate for filtering crankcase oil for engine lubrication. If they are inadequate for the turbocharger's requirements, special oil filters and oil/water separators may be used.

The oil used for cooling may be subject to aeration. Therefore, having the oil flow through an air separator may be merited. In addition, shaft 504, stiffener 516 and rotor 330 may generate wind shear inside the entire cavity that motor housing 302 forms. The positioning and direction of ducts 350 and 352 and any other oil openings and ducts should account for the wind shear. Accordingly, the oil should not be sprayed against the flow of wind shear such that the oil does not slow the flow of air and thereby undesirably slow the rotor. At minimum, one of these ducts must be present to provide the stator coils with direct contact oil cooling. Having more than one duct may be more desirable because they provide more even distribution of the oil cooling around the stator.

To account for the flow of wind shear inside the rotor, the ducts likely should direct oil nearly tangentially to the stators circumference and in the direction of the internal motor housings wind shear. The jets can face the stator from an axial or a radial direction or any oblique combination thereof. For example, the jets could be placed in, or at least concentrated in circumferential positions between the 9:00 or 10:00 to 2:00 or 3:00 positions.

Moving the oil off the motor parts may be merited. Oil that overheats on the stator 332, shaft 504 or stiffener 516 may start coking at about 280° C. Coking on the shaft or stiffener can affect the balance of shaft 504 and increase the shaft's and stiffener's inertia. Coking oil also may plug up passages including ducts 350 and 352. Even if coking does not occur, oil on the shaft or stiffener can affect shaft balance negatively and can increase inertia and drag resistance undesirably.

Thus, the shaft may include one or more flingers, which are geometric features that shed fluid radially outward as they rotate. For example, oil flingers 520 and 522 (FIGS. 5, 8 and 9) may be positioned on the shaft to keep oil out of the turbine 200 and compressor 400. That is, as any oil flows along the shaft toward the turbine or compressor, the oil encounters the flingers where it is flung radially outward away from the turbine or compressor. Either the oil is flung into sump 336, or the oil is flung toward other structure in motor housing 302 and drips from there into the sump.

Because the flingers remove oil from the shaft 504, the effective mass of the shaft does not increase significantly due to oil on the shaft. Therefore, lag from the inertia effects during quick spool-up of the turbocharger 100 is reduced. The oil flingers also may contribute to the de-aeration of the oil by removing the oil from the spinning shaft and throwing it onto the stator coils and motor housing walls.

Shaft assembly 500 may have flingers aligned with the sides of stator 332, for example, flingers 524 and 526 around stiffener 516 (FIG. 5). These flingers may circulate oil back onto the stator 332. Oil may have to be aimed to avoid tray 324 although spraying oil on the outside of the tray will conduct heat away from the tray. Any temperature decrease of the tray may draw heat from the stator.

Additional flingers 524 and 526 may be included to shed oil away from the rotor 330, or to shed oil in a direction that reaches and further cools stator 332.

The flingers may be added to or incorporated into shaft 504, stiffener 516 or some other component coupled to the shaft.

Motor housing 302 may form one or more passageways 318 in wall 338 (FIGS. 5 and 6), which surround stator 332. The passageway may connect to the coolant inlet 320 (FIG. 3) through which coolant may flow. The coolant may be the coolant from the existing engine cooling system. Coolant from a cooling system other than the vehicle's system, such as engine oil or a separate oil system may be used with the passageways. Ambient air could also be used, although air may not conduct heat as well as most liquids.

If passageway 318 carries oil, wall 338 may include radial or other openings to allow oil to drip or spray onto the coils of stator 332.

A heat conducting medium 346 (FIG. 6) of a material that conducts heat well (e.g., aluminum or copper) contacts stator to transmits heat from the stator to wall 338 and the coolant in passageway 318. The coolant cools the surrounding structures of motor housing 302 to conduct heat from the motor housing and other parts of motor 300.

Coolant inlet 348 (FIG. 2) and coolant outlet 320 (FIG. 3) to passageway 318 (FIGS. 5 and 6) may be positioned so that coolant travels around most of stator 332 from the coolant's entry into the passageway to the coolant's draining from the passageway. The heat removed by the coolant adds to the heat load of the engine cooling system. Thus, the engine's cooling system may need to be larger or have a greater capacity to expel the added heat load.

As an example of the turbocharger's operation, consider the situation where a vehicle engine is at idle while the vehicle is at a traffic light. If the driver wants to accelerate rapidly, the exhaust energy to the turbocharger naturally lags. The amount of exhaust gas alone may be unable then to provide sufficient torque to rotate turbine 200 fast enough. Consequently, the shaft 504 would not rotate fast enough for the compressor 200 to provide effective boost.

Meanwhile, controller 600 obtains speed information about the shaft 504 and/or the rotor 330 from a speed sensor (not shown). A temperature sensor adjacent to or in contact with stator 332 may feed stator temperature data to the controller. The controller also may receive data from sensors about the current operation of the engine, such as throttle information, exhaust output and air input.

Using these data, the controller 600 determines when the shaft speed is undesirably low and causes motor 300 to spin. The motor rotates shaft 504 to drive compressor 400 to provide desired boost. The motor increases speed quickly, which spins the compressor much sooner than turbine 200 could do on its own. When engine exhaust gas becomes sufficient to drive the turbine, the controller may cause a decrease or cut in electrical power to the motor.

Motor 300 also can act to reduce the output from the turbine 200. If the controller 600 determines that exhaust output to the turbine 200 is too great (e.g., based upon data from pressure sensors), the controller 600 may cause the motor to act as a brake to decrease the turbine's output. The motor may also be used as an alternator to generate electricity when the motor acts as a brake. For example, where turbine 200 can provide excess power to the shaft 504, the motor may draw off this excess power as electricity. This may occur, for example, during peak engine load points such as hill climbs. The generated electrical power may be used to charge the vehicle's battery or to power electrical devices.

### CLOSING COMMENTS

Throughout this description, the embodiments and examples shown should be considered as exemplars, rather than limitations on the apparatus and procedures disclosed or claimed. Although many of the examples involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the described methods. Acts, elements and features discussed only in connection with one embodiment are not intended to be excluded from a similar role in other embodiments.

For means-plus-function limitations recited in the claims, the means are not intended to be limited to the means disclosed in this application for performing the recited function, but are intended to cover in scope any means, known now or later developed, for performing the recited function.

As used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims. Use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

It is claimed:

1. An electrically controlled turbocharger comprising:
a shaft having an axis of rotation;
a turbine mounted on the shaft;
a compressor mounted on the shaft;
a motor comprising a rotor attached to the shaft and a stator around the rotor;
channel within the turbocharger and directed onto the motor, the channel including at least one passage onto the motor and directed at the stator

2. The electrically controlled turbocharger of claim 1 wherein the motor is disposed between the turbine and the compressor.

3. The electrically controlled turbocharger of claim 1 further comprising at least one flinger operably connected to the shaft and extending radially outward from the axis of the shaft.

4. The electrically controlled turbocharger of claim 1 further comprising a jacket around the stator having at least one passage, the jacket's passage being operably connectable to a source of cooling liquid and a heat conducting wall between a first portion of the jacket and the stator.

5. The electrically controlled turbocharger of claim 4 wherein a second portion of the jacket contacts the stator.

6. The electrically controlled turbocharger of claim 4 further comprising a heat conducting medium attached to the jacket, the heat conductor contacting the stator.

7. The electrically controlled turbocharger of claim 1 further comprising a source of oil and an inlet from the source of oil to the channel, wherein at least one passage through a portion of the housing has a valve controlling the flow of oil through the passage.

8. The electrically controlled turbocharger of claim 1 further comprising a source of oil and an inlet from the source of oil to the channel, wherein the size and orientation of the passage and the pressure of the oil accounts for air movement in the motor.

9. The electrically controlled turbocharger of claim 8 wherein at least one passage is sized to produce a fan, cone, straight stream, or dribbles.

10. The electrically controlled turbocharger of claim 8 wherein at least one passage sprays oil at predetermined intervals.

11. The electrically controlled turbocharger of claim 8 wherein at least one passage faces the stator from an axial direction relative to the axis of rotation of the shaft.

12. The electrically controlled turbocharger of claim 8 wherein at least one passage faces the stator from a radial direction relative to the axis of rotation of the shaft.

13. The electrically controlled turbocharger of claim 8 wherein at least one passage faces the stator from an oblique direction relative to the axis of rotation of the shaft.

14. The electrically controlled turbocharger of claim 1 further comprising a stiffener around the shaft adjacent the motor.

15. The electrically controlled turbocharger of claim 14 wherein the stiffener mounts to the shaft by an interference fit.

16. The electrically controlled turbocharger of claim 1 wherein the rotor has two ends, the turbocharger further comprising at least one oil flinger positioned adjacent one end of the rotor, the oil flinger extending radially out from the shaft.

17. The electrically controlled turbocharger of claim 1 further comprising a stiffener around the shaft adjacent the rotor, wherein the rotor has two ends, the turbocharger further comprising at least one oil flinger positioned adjacent one end of the rotor, the oil flinger extending radially out from the stiffener.

18. The electrically controlled turbocharger of claim 1 further comprising a source of oil and an inlet from the source of oil to the channel and further comprising an oil pump connected to the source of oil and supplying oil to moving parts in the turbocharger irrespective of any other oil pump pumping oil to any other part of such an engine.

19. The electrically controlled turbocharger of claim 18 further comprising an insulator disposed between the turbine end and the motor, the insulator being a ceramic material.

20. The electrically controlled turbocharger of claim 19 wherein at least a portion of the housing is made of ceramic material.

21. The electrically controlled turbocharger of claim 1 further comprising a vent in the housing adjacent the motor to limit formation of reduced pressure in the housing around the motor.

22. The electrically controlled turbocharger of claim 1 including a tray between at least one portion of the stator and the shaft positioned to block oil flow toward the rotor.

23. The electrically controlled turbocharger of claim 1 further comprising a source of oil and an inlet from the source of oil to the channel, further comprising at least two bearings associated with the shaft, the bearings receiving oil under pressure from the source of oil, at least one passage through a portion of the housing having a valve, the valve limiting the flow of oil through the passage until the pressure of oil in the bearings is at least at a predetermined pressure.

24. A motor assembly for an electrically controlled turbocharger comprising:
a rotatable shaft having an axis of rotation;
a motor comprising a housing and a rotor, the rotor extending around the shaft and a stator around the rotor, the rotor rotatable inside the stator;
a source of oil, at least one passage through a portion of the housing and positioned such that at least some oil flowing through the passage contacts the stator.

25. The motor assembly of claim 24 wherein the size of the passage and the pressure of the oil are such that oil exiting the passage sprays from the passage to the stator.

26. The motor assembly of claim 25 further comprising at least one flinger operably connected to the rotating shaft and extending radially outward from the axis of the rotating shaft.

27. The electrically controlled turbocharger of claim 24 further comprising a jacket around the stator having at least one passage, the passage being operably connectable to a source of cooling liquid and a heat conducting medium between a first portion of the jacket and the stator.

28. The electrically controlled turbocharger of claim 24 wherein a second portion of the jacket contacts the stator.

29. The electrically controlled turbocharger of claim 24 wherein at least one passage through a portion of the housing has a valve controlling the flow of oil through the passage.

30. The electrically controlled turbocharger of claim 24 wherein the sized and orientation of the passage and the pressure of the oil accounts for air movement in the motor.

31. The electrically controlled turbocharger of claim 30 wherein at least one passage is sized to produce a fan, cone, straight stream or dribbles.

32. The electrically controlled turbocharger of claim 30 wherein at least one passage sprays oil at predetermined intervals.

33. The electrically controlled turbocharger of claim 30 wherein at least one passage faces the stator from an axial direction relative to the axis of rotation of the shaft.

34. The electrically controlled turbocharger of claim 30 wherein at least one passage faces the stator from a radial direction relative to the axis of rotation of the shaft.

35. The electrically controlled turbocharger of claim 30 wherein at least one passage faces the stator from an oblique direction relative to the axis of rotation of the shaft.

36. The electrically controlled turbocharger of claim 24 further comprising a stiffener around the shaft adjacent the motor.

37. The electrically controlled turbocharger of claim 36 wherein the stiffener mounts to the shaft by an interference fit.

38. The electrically controlled turbocharger of claim 24 wherein the rotor has two ends, the turbocharger further comprising at least one oil flinger positioned adjacent one end of the rotor, the oil flinger extending radially out from the shaft.

39. The electrically controlled turbocharger of claim 24 further comprising a stiffener around the shaft adjacent the rotor, wherein the rotor has two ends, the turbocharger further comprising at least one oil flinger positioned adjacent one end of the rotor, the oil flinger extending radially out from the stiffener.

40. The electrically controlled turbocharger of claim 24 further comprising an independent oil pump connected to a source of oil and supplying oil to moving parts in the turbocharger irrespective of any other oil pump pumping oil to any other part of such an engine.

41. The electrically controlled turbocharger of claim 24 further comprising a vent in the housing adjacent the motor to limit formation of reduced pressure in the housing around the motor.

42. The electrically controlled turbocharger of claim 24 including a tray between at least one portion of the stator and the shaft positioned to block oil flow toward the rotor.

43. A motor assembly for an electrically controlled turbocharger comprising:
a rotatable shaft having an axis of rotation;
a motor comprising a rotor extending around the shaft and a stator around the rotor, the rotor rotatable inside the stator;
means for spraying oil from a source of oil onto at least a portion of the stator.

44. A process for cooling parts of an electrically controlled turbocharger, the electrically controlled turbocharger comprising a turbine, a shaft, a motor and a compressor, the motor comprising a stator and a rotor, the process comprising:
the turbine rotating the shaft in response to engine exhaust passing through the turbine;
the compressor rotating in response to rotation of the shaft and compressing air;
spraying oil from a source of oil onto a stator of the motor to transfer heat from the stator to the oil, the oil flowing from a housing of the motor to the source of oil.

45. A process for cooling parts of a motor of an electrically controlled turbo-charger, the motor having a housing, a rotor rotatable by a shaft and a stator around the rotor, the process comprising spraying oil from a source of oil onto the stator to transfer heat from the stator to the oil, the oil flowing from the housing to the source of oil.
